(19) United States
(12) Patent Application Publication
(10) Pub. No.: US 2025/0058709 A1
(43) Pub. Date: Feb. 20, 2025

(54) SYSTEM AND METHOD FOR CONTROLLING VIRTUAL SOUND FOR VEHICLES

(71) Applicant: HYUNDAI MOBIS CO., LTD., Seoul (KR)

(72) Inventors: Jae Yong SEO, Yongin-si (KR); Kyung Hwan PARK, Yongin-si (KR); Hyeon Cheol JO, Yongin-si (KR); Bo Seok KANG, Yongin-si (KR)

(73) Assignee: HYUNDAI MOBIS CO., LTD., Seoul (KR)

(21) Appl. No.: 18/666,637

(22) Filed: May 16, 2024

(30) Foreign Application Priority Data
Aug. 16, 2023 (KR) 10-2023-0106901
Aug. 16, 2023 (KR) 10-2023-0106902
Aug. 16, 2023 (KR) 10-2023-0106903
Aug. 16, 2023 (KR) 10-2023-0106904
Aug. 16, 2023 (KR) 10-2023-0106905

(51) Int. Cl. B60Q 5/00

(52) U.S. Cl. CPC B60Q 5/008; B60Q 5/006

(57) ABSTRACT

A system for controlling virtual sound for a vehicles including one or more processors configured to execute instructions and a memory storing the instructions, the execution of the instructions configures the one or more processors to compare driving information with a sound generation condition for each driving device of the vehicle, determine whether a sound generation condition of a respective driving device matches the driving information, and, responsive to determining that the respective driving device matches the driving information, outputting a virtual sound set for the respective driving device through a sound output device.

### CROSS-REFERENCE TO RELATED APPLICATIONS

This application claims the benefit under 35 USC § 119(a) of Korean Patent Application Nos. 10-2023-0106901, filed on Aug. 16, 2023, 10-2023-0106902, filed on Aug. 16, 2023, 10-2023-0106903, filed on Aug. 16, 2023, 10-2023-0106904, filed on Aug. 16, 2023, and 10-2023-0106905, filed on Aug. 16, 2023, the entire disclosures of which are incorporated herein by reference for all purposes.

### BACKGROUND

### 1. Field

Exemplary embodiments of the present disclosure relate to a system and method for controlling virtual sound for vehicles.

### 2. Description of the Related Art

In general, an electric vehicle generates no engine sound since it uses an electric motor as a main power source while traveling, which causes the vehicle to incur very low noise. Hence, there is a risk that a safety accident may occur due to the inability of pedestrians (especially, who are visually impaired) to recognize approaching vehicles. To improve this issue, a virtual engine sound system (VESS) has been developed that outputs a virtual engine sound, namely, a pedestrian protection sound, when a vehicle travels at low speed or reverses, thereby enabling pedestrians (blind, elderly, low-hearing people, etc.) to easily recognize the approach of vehicles. Moreover, many countries have made it mandatory for electric vehicles to be equipped with VESSs that artificially output engine noise.

In addition, since an electric vehicle or a vehicle equipped with an in-wheel system has much smaller internal noise compared to an existing engine vehicle, there is increasing the number of users (or drivers) who are sensitive to (or react to) driving device operation noise (e.g., steering device operation noise, braking device operation noise, power transmission device operation noise, suspension device operation noise, etc.), operating noise in electric corner (e-corner) module driving mode, operating noise incurred by in-wheel system actuation, operating noise incurred by braking system actuation, and component operation noise (e.g., wiper operation noise, air-conditioning system operation noise, window operation noise, sunroof operation noise, electric seat operation noise, pop-up monitor operation noise, side-view mirror operation noise, etc.), which were not problematic in the existing engine vehicle.

Therefore, research is underway to reduce the level of operating noise of these devices in the industry. However, because there are limitations to reducing the level of operating noise of the devices, research is needed on how to lower a user's interest in the operating noise of each device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, system for controlling virtual sound for a vehicle includes one or more processors configured to execute instructions and a memory storing the instructions, the execution of the instructions configures the one or more processors to compare driving information with a sound generation condition for each driving device of the vehicle, determine whether a sound generation condition of a respective driving device matches the driving information, and, responsive to determining that the respective driving device matches the driving information, outputting a virtual sound set for the respective driving device through a sound output device.

The processors may be further configured to, responsive to a determination that two or more driving devices include respective sound generation conditions that match the driving information as matching driving devices, controlling a respective frequency of a respective virtual sound set for each of the matching driving devices while outputting a respective virtual sound for each of the matching driving devices.

The processors may be further configured to tune respective frequencies, based on a respective, predetermined priority for driving device.

The processors may be further configured to control one or more of a frequency and a volume of a respective virtual sound based on respective frequency characteristics and a respective level of operating noise incurred by the driving devices.

The processors may be further configured to select one or more sound output devices to output respective virtual sounds based on a sound output allocation table and output the respective virtual sounds through the one or more selected sound output devices.

In a general aspect, here is provided a system for controlling virtual sound for a vehicle including one or more processors configured to execute instructions and a memory storing the instructions, wherein execution of the instructions configures the one or more processors to control a frequency of a virtual sound based on driving information during an operation of a vehicle system and output the virtual sound at the controlled frequency through the a sound output device.

The vehicle system may be an e-corner system, and the processors may be further configured to determine a mode type of an e-corner driving mode based on the driving information and output a virtual sound set for the determined mode type through the sound output device.

The processors may be further configured to control a frequency of a virtual sound set for the determined mode type based on input factors and output the virtual sound at the controlled frequency through the sound output device.

The processors may be further configured to control one or more of a frequency and a volume of a respective virtual sound based on one or more frequency characteristics and a level of an operating noise incurred in the e-corner driving mode.

The vehicle system may be an in-wheel system and the processors may be further configured to control a volume of the virtual sound to output the virtual sound corresponding to a level of operating noise of the in-wheel system.

The processors may be further configured to obtain an input factor in response to an actuation of the in-wheel system from the driving information and control the frequency of the virtual sound based on the obtained input factor.

The vehicle system may be a braking system and the processors may be further configured to obtain an input factor in response to an actuation of a braking system from the driving information and control the frequency of the virtual sound based on the obtained input factor.

The processors may be further configured to control a volume of the virtual sound to output the virtual sound corresponding to a noise level of an operating noise of the braking system.

The processors may be further configured to change the virtual sound set for an input factor in response to an actuation of the vehicle system to a sound source selected by a user and output the changed sound source as a virtual sound.

In a general aspect, here is provided a system for controlling virtual sound for a vehicle including a communication device configured to communicate with an electronic control unit (ECU) in a vehicle, one or more processors configured to execute instructions, and a memory storing the instructions, wherein execution of the instructions configures the one or more processors to receive a component operation signal and information of a type of an operating component from the communication device and output a virtual sound corresponding to component operation noise incurred by the operating component through a sound output device.

The component operation signal may be a signal for a start and an end of a component operation.

The system may include a storage device configured to store one or more of frequency characteristics for each component operation noise, a sound source, a virtual sound generation algorithm, a virtual sound generated using a pre-generated default virtual sound or a sound source selected by a user, and a sound output allocation table according to the virtual sound.

The virtual sound may be one or more of frequency characteristics for each component operation noise with a sound source and frequency characteristics of the component operation noise as an element of music to hide the component operation noise.

The processors may be further configured to load, from a storage device, a default virtual sound for the operating component based on one of the component operation signal and a virtual sound generated from a user selected sound source and select the sound output device from one or more sound output devices to output the default virtual sound through the selected sound output as specified in a sound output allocation table.

The sound output allocation table may include sound output allocation values indicating an effect in inducing component operation noise to the sound source according to a predetermined value based on an installed position and a number of sound output devices for the vehicle and the sound output allocation table may include sound volume and equalizer information for each sound output.

### BRIEF DESCRIPTION OF THE DRAWINGS

FIG. 1 is a block diagram schematically illustrating a configuration of a system for controlling virtual sound for vehicles according to an embodiment of the present disclosure.

FIG. 2 is an exemplary view illustrating positions at which a plurality of sound output modules are arranged in a vehicle according to an embodiment of the present disclosure.

FIG. 3 is a flowchart for explaining a method of outputting virtual sound in a chassis system according to an embodiment of the present disclosure.

FIG. 4 is a flowchart for explaining a method of outputting virtual sound in an e-corner module system according to an embodiment of the present disclosure.

FIG. 5 is a flowchart for explaining a method of outputting virtual sound in an in-wheel system according to an embodiment of the present disclosure.

FIG. 6 is a flowchart for explaining a method of outputting virtual sound in a braking system according to an embodiment of the present disclosure.

FIG. 7 is a flowchart for explaining a method of outputting virtual sound in response to operation of small vehicle components according to an embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

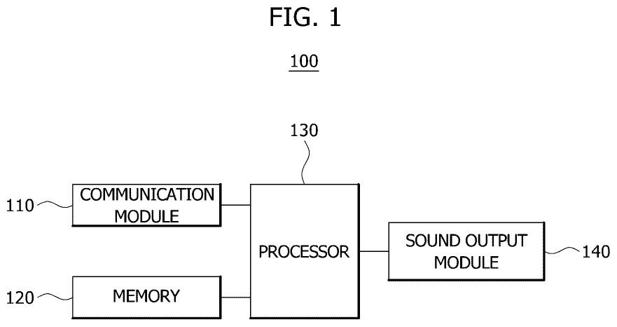

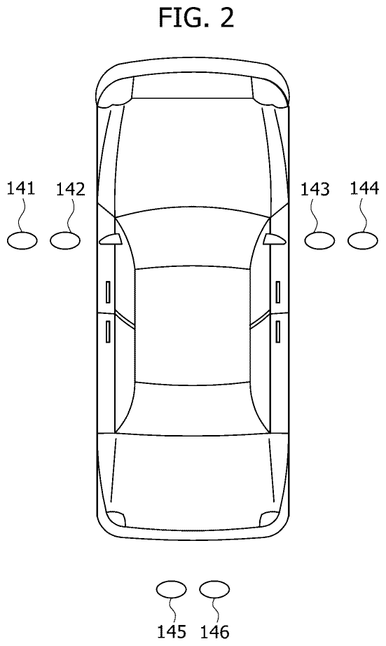

FIG. 1 is a block diagram schematically illustrating a configuration of a system for controlling virtual sound for vehicles according to an embodiment of the present disclosure. FIG. 2 is an exemplary view illustrating positions at which a plurality of sound output modules (i.e., sound output devices) are arranged in a vehicle according to an embodiment of the present disclosure.

Referring to FIG. 1, the system for controlling virtual sound for vehicles, which is designated by reference numeral 100, according to the embodiment of the present disclosure includes a communication module 110, a memory 120, a processor 130, and a sound output module 140.

The communication module 110 (i.e., a communication device) may support the system for controlling virtual sound for vehicles 100 to communicate with sensors and/or an electric control unit (ECU), etc. mounted on the vehicle. Examples of the sensors may include a microphone, a camera (image sensor), a distance sensor, a wheel speed sensor, an advanced driver assistance system (ADAS) sensor, a 3-axis accelerometer, and/or an inertial measurement unit (IMU). Examples of the ECU may include a motor control unit (MCU) and/or a vehicle control unit (VCU).

The communication module 110 may receive, from the sensors and/or the ECU mounted on the vehicle, driving information that includes a brake operation on/off status, a brake cylinder pressure, a vehicle longitudinal/lateral acceleration, a vehicle speed, gear values (P, R, N, and D), a steering angle, a steering angular velocity, a motor torque, wheel speeds (for 4 front/rear wheels), an engine RPM and torque, an e-corner module driving mode, an in-wheel motor torque, whether an anti-lock brake system (ABS) is in operation, component operation information, and so on. The component operation information may include component operation signals (e.g., component operation start and end signals) and information on the type of operating component. Examples of the type of operating component include a wiper, an air-conditioning system, a window, a sunroof, an electric seat, a pop-up monitor, and a side-view mirror. Examples of the component operation signals include wiper operation start/end, air-conditioning system operation start/end, window operation start/end, sunroof operation start/end, electric seat operation start/end, pop-up monitor operation start/end, and side-view mirror operation start/end.

The communication module 110 may be a device that includes hardware and software required to transmit and receive signals such as control signals or data signals through wired or wireless connection with other network devices.

The memory 120 is a component that stores data related to the operation of the system for controlling virtual sound for vehicles 100. In particular, the memory 120 may store an application (program or applet) that determines at least one of a driving device and a driving mode based on the driving information and outputs a virtual sound in response to at least one of the determined driving device and driving mode. The stored information may be selected by the processor 130 as needed. In other words, the memory 120 stores various types of data generated during the execution of an operating system or a control application (program or applet) for actuating the system for controlling virtual sound for vehicles 100. In addition, the memory 120 may store frequency characteristics for each driving device noise, frequency characteristics for each component operation noise (e.g., wiper operation noise, air-conditioning system operation noise, window operation noise, sunroof operation noise, electric seat operation noise, pop-up monitor operation noise, side-view mirror operation noise, or the like), a sound source, a virtual sound generation algorithm, pre-generated virtual sounds (e.g., default virtual sound and virtual sound generated using the sound source selected by the user), a sound output module allocation table, and so on. Here, the virtual sound may refer to a sound that naturally draws the user's interest in component operation noise toward the sound source by mixing the frequency characteristics for each component operation noise with the sound source in the form of a background, namely, utilizing the frequency characteristics of the component operation noise as a background beat of music to arrange the sound source with a different feeling from the component operation noise. Hence, the virtual sound according to this embodiment is different from noise cancelling that cancels existing noise, in that it naturally draws the user's attention toward the sound source.

The memory 120 may include magnetic storage media or flash storage media in addition to volatile storage devices that require power to maintain stored information, but the present disclosure is not limited thereto.

The sound output module 140 may output a virtual sound under the control of the processor 130.

The sound output module 140 may include a sound generator that generates a virtual sound signal with the characteristics of target sound using sound control signals and stored sound source data, an amplifier that amplifies the generated virtual sound signal, and a speaker such as a woofer that converts the amplified virtual sound signal into a virtual driving sound for outputting it. The speaker is installed in at least one of the interior and exterior of the vehicle. Preferably, a plurality of speakers may be installed and used in the vehicle in order to output virtual sounds.

The sound output module 140 may output a noise sound based on the sound output module allocation table (not shown) under the control of the processor 130.

The sound output module 140 may consist of a plurality of sound output modules, each simply described as a speaker. Thus, the vehicle may be equipped with front speakers (mid-bass+treble) 141 and 142, front tweeter speakers (treble) 143 and 144, and rear speakers (mid-bass+treble) 145 and 146, as illustrated in FIG. 2.

The processor 130 is an entity intended to control the system for controlling virtual sound for vehicles 100, and may be implemented as an electronic control unit (ECU), a central processing unit (CPU), a processor, or a system on chip (SoC). The processor 130 may run an operating system or application to control a plurality of hardware components or software components connected to the processor 130, and may perform various data processing operations. The processor 130 may be configured to execute at least one command stored in the memory 120 and store the result data of execution in the memory 120.

The processor 130 may generate a virtual sound using the sound source selected by the user based on the virtual sound generation algorithm.

The processor 130 may store the virtual sound generated using the sound source selected by the user in the memory 120.

The processor 130 may determine at least one of a driving device, a driving mode, a braking mode, and an operating component based on the driving information received through the communication module 110, and may cause the sound output module 140 to output a virtual sound in response to at least one of the determined driving device, driving mode, braking mode, and operating component. In this case, the processor 130 may select a sound output module 140 to output the virtual sound based on the sound output module allocation table. In other words, since a plurality of sound output modules 140 are provided inside and outside the vehicle, the processor 130 may control the plurality of sound output modules 140 to selectively output virtual sounds. Here, the sound output module allocation table stores a sound output module allocation value that has the best effect in inducing operating noise to the sound source by performing a test based on the installed position and number of sound output modules 140 for each vehicle. In this case, the sound output module allocation table may further include sound volume and equalizer information for each sound output module 140.

The processor 130 may output different virtual sounds depending on a chassis system, an e-corner module system, an in-wheel system, a braking system, etc.

First, the operation of the processor 130 for outputting virtual sound in the chassis system will be described.

The chassis system functionally includes driving devices such as a power transmission device (for an internal combustion engine or a motor), a braking device, a steering device, and a suspension device, and there is a virtual sound for each driving device. The processor 130 may control the virtual sound for each driving device based on the driving information of the vehicle.

If the processor 130 receives driving information through the communication module 110, the processor 130 may check at least one driving device (e.g., a steering device, a braking device, a power transmission device, a suspension device, or the like) based on the driving information, and may output a virtual sound set for at least one checked driving device. Here, the driving information may include a brake operation on/off status, a brake cylinder pressure, a vehicle longitudinal/lateral acceleration, a vehicle speed, gear values (P, R, N, and D), a steering angle, a steering angular velocity, a motor torque, wheel speeds (for 4 front/rear wheels), an engine RPM and torque, and so on.

Specifically, if the processor 130 receives driving information, the processor 130 may compare the driving information with a sound generation condition for each driving device to determine whether a driving device is present whose sound generation condition matches the driving information. If the driving device is present whose sound generation condition matches the driving information, the processor 130 may output a virtual sound set for that driving device.

For example, a sound generation condition and virtual steering sound are set for the steering device, a sound generation condition and virtual braking sound are set for the braking device, a sound generation condition and virtual power transmission sound are set for the power transmission device, and a sound generation condition and virtual suspension sound are set for the suspension device. Accordingly, when the driving information includes a sound generation condition for the steering device, the processor 130 may output a virtual steering sound. In addition, when the driving information includes a sound generation condition for the power transmission device, the processor 130 may output a virtual power transmission sound.

The processor 130 may load, from the memory 120, the default virtual sound for the driving device or the virtual sound generated using the sound source selected by the user to output the above virtual sound through the sound output module 140 specified in the sound output module allocation table.

Since a plurality of sound output modules 140 are provided inside and outside the vehicle, the processor 130 may control the plurality of sound output modules 140 to selectively output virtual sounds. In other words, the processor 130 may allocate a sound output module 140 to output the virtual sound based on the sound output module allocation table. Here, the sound output module allocation table may store a sound output module allocation value that has the best effect in inducing driving device operation noise to the sound source by performing a test based on the installed position and number of sound output modules 140 for each vehicle.

In addition, the processor 130 may change the virtual sound set as default for each driving device to a sound source selected by the user, and may output the changed sound source as a virtual sound. In other words, when the vehicle is shipped, a default virtual sound may be set for each driving device. Accordingly, the user may change the default virtual sound set as default for each driving device to his/her desired sound source. For example, the user may change the default virtual sound to various sound sources such as DYNAMIC, CYBER, and SPORT.

Moreover, the processor 130 may control at least one of the frequency and volume of the virtual sound based on at least one of the frequency characteristics and level for each driving device operation noise.

To this end, the system for controlling virtual sound for vehicles 100 according to the present disclosure may further include a microphone (not shown) that detects operating noise incurred by each driving device while the vehicle is traveling.

The processor 130 may control the volume of the virtual sound to output the virtual sound corresponding to the level of the driving device operation noise detected through the microphone.

For example, the processor 130 may output a louder virtual steering sound because, if the steering wheel is turned quickly, it makes a lot of noise. In addition, if sudden braking occurs, the processor 130 may output a louder virtual sound corresponding to the amount of pressure on the sudden braking.

Moreover, the processor 130 may control a virtual sound at a target frequency corresponding to the frequency characteristic of the driving device operation noise detected through the microphone to be output.

For example, since the operating noise of the power transmission device is mostly in a low frequency band, the processor 130 may control the virtual sound in the low frequency band to be output.

In addition, if there are a plurality of driving devices in operation, the processor 130 may control the frequency of the virtual sound set for each driving device while outputting the virtual sound for each driving device. In other words, when a plurality of driving devices are in operation, the processor 130 may tune the frequency of the virtual sound with high priority to be higher based on the priority set for each driving device, and may output the same.

For example, when the steering device and the braking device are actuated simultaneously, the processor 130 may tune the virtual braking sound for the brake device, which has a higher priority than the steering device, to have a higher frequency than the virtual steering sound in order to overlap the frequencies of the virtual steering sound and the virtual braking sound, and may output the tuned virtual braking sound and virtual steering sound through the sound output module 140. In this case, the occupant may hear the virtual braking sound better than the virtual steering sound.

In addition, when the power transmission device and the steering device are actuated simultaneously, the processor 130 may output a virtual sound at a frequency that targets the operating noise of the power transmission device and a frequency that targets the operating noise of the steering device through the sound output module 140 by tuning the virtual steering sound for the steering device, which has a higher priority than the power transmission device, to have a higher frequency than the virtual power transmission sound.

In addition, when the vehicle speed is less than a reference value (e.g., 20 kph) and the gear value is P, the processor 130 may determine that the vehicle is in a parking mode and output the virtual steering sound for the steering device and the virtual braking sound for the braking device through the sound output module 140.

Moreover, when the plurality of driving devices are actuated in the chassis system, the processor 130 may control the plurality of sound output modules 140 to selectively output virtual sounds for different driving devices, and may control the virtual sound for each driving device to be output at a specific frequency therefor.

Next, the operation of the processor 130 for outputting virtual sound in the e-corner module system will be described.

The e-corner module is a component that independently controls four wheels, and is connected to the wheels of the vehicle to perform overall operations such as driving, braking, steering, and suspension. The e-corner module may consist of a plurality of e-corner modules connected to respective wheels. The plurality of e-corner modules may independently perform operations such as driving, braking, steering, and suspension for individual wheels. Each e-corner module includes driving devices such as a power transmission device (for an in-wheel system), a braking device, a steering device, and a suspension device, and there is a virtual sound for each driving device.

The processor 130 may control the virtual sound for each driving device based on the driving information of the vehicle.

If the processor 130 receives driving information through the communication module 110, the processor 130 may check an e-corner module driving mode based on the driving information and output a virtual sound set for the checked e-corner module driving mode.

Specifically, if the processor 130 receives driving information of the vehicle, the processor 130 may determine whether the e-corner module driving mode is present in the driving information. Here, the driving information may include a brake operation on/off status, a brake cylinder pressure, a vehicle longitudinal/lateral acceleration, a vehicle speed, gear values (P, R, N, and D), a steering angle, a steering angular velocity, a motor torque, wheel speeds (for 4 front/rear wheels), an engine RPM and torque, an e-corner module driving mode, and so on. The e-corner module driving mode may include a crap driving mode, a zero turn mode, a diagonal driving mode, a pivot turn mode, etc.

If the e-corner module driving mode is present in the driving information, the processor 130 may control the frequency of the virtual sound set for that e-corner module driving mode based on the input factor, and may output the virtual sound at the controlled frequency through the sound output module 140. Here, the input factor may refer to a parameter excluding the e-corner module driving mode from the driving information.

Since a virtual sound is set for each e-corner module driving mode, the processor 130 may output the virtual sound set for that e-corner module driving mode.

For example, a first virtual sound is set for the crap driving mode, a second virtual sound is set for the zero turn mode, a third virtual sound is set for the diagonal driving mode, and a fourth virtual sound is set for the pivot turn mode. Accordingly, the processor 130 may output the virtual sound set for the e-corner module driving mode through the sound output module 140.

Even if a specific e-corner module driving mode is in operation, input factors may be different in the specific e-corner module driving mode. Therefore, the processor 130 may control the frequency of the virtual sound set for the specific e-corner module driving mode based on the input factor, and may output the virtual sound at the controlled frequency through the sound output module 140.

For example, a case where the driver selects a crab driving mode from among the e-corner module driving modes will be described. The processor 130 may output a virtual sound set for the crab driving mode. In this case, even in the crab driving mode, the input factors such as vehicle speed and in-wheel speed may be different. Accordingly, when the input factors such as vehicle speed and in-wheel speed are higher than reference values, the processor 130 may output the virtual sound set for the crab driving mode at a higher frequency.

In addition, the processor 130 may control the volume of the virtual sound to output the virtual sound corresponding to the level of the operating noise in the e-corner module driving mode.

If the e-corner module driving mode is not present in the driving information, the processor 130 may check at least one driving device (e.g., a steering device, a braking device, a power transmission device, a suspension device, or the like) based on the driving information, and may output a virtual sound set for at least one checked driving device. If the e-corner module driving mode is not present in the driving information, a description thereof will be omitted since the processor 130 performs the same operation as the processor 130 in the chassis system.

In addition, the processor 130 may load, from the memory 120, the default virtual sound set for the e-corner module driving mode or the virtual sound generated using the sound source selected by the user to output the above virtual sound through the sound output module 140 specified in the sound output module allocation table.

Since a plurality of sound output modules 140 are provided inside and outside the vehicle, the processor 130 may control the plurality of sound output modules 140 to selectively output virtual sounds. In other words, the processor 130 may allocate a sound output module 140 to output the virtual sound based on the sound output module allocation table.

In addition, the processor 130 may change the virtual sound set as default for each e-corner module driving mode to a sound source selected by the user, and may output the changed sound source as a virtual sound. In other words, when the vehicle is shipped, a default virtual sound may be set for each e-corner module driving mode. Accordingly, the user may change the default virtual sound set as default for each e-corner module driving mode to his/her desired sound source. For example, the user may change the default virtual sound to various sound sources such as DYNAMIC, CYBER, and SPORT.

Moreover, the processor 130 may control at least one of the frequency and volume of the virtual sound based on at least one of the frequency characteristics and level for each e-corner module driving mode operation noise.

To this end, the system for controlling virtual sound for vehicles 100 according to the present disclosure may further include a microphone (not shown) that detects operating noise incurred in each e-corner module driving mode while the vehicle is traveling.

The processor 130 may control the volume of the virtual sound to output the virtual sound corresponding to the level of the driving device operation noise detected through the microphone.

Next, the operation of the processor 130 for outputting virtual sound in the in-wheel system will be described.

The in-wheel system is a system that integrates brakes, gears, etc. by inserting a motor into the wheels of the vehicle, which may allow the motor to directly control the individual wheels of the vehicle. In the in-wheel system, the processor 130 may control the output of virtual sound based on the driving information of the vehicle.

When the in-wheel system is actuated, the processor 130 may receive the driving information of the vehicle through the communication module 110. Here, the driving information may include a brake operation on/off status, a brake cylinder pressure, a vehicle longitudinal/lateral acceleration, a vehicle speed, gear values (P, R, N, and D), a steering angle, wheel speeds (for 4 front/rear wheels), an in-wheel motor torque, and so on.

If the processor 130 receives driving information, the processor 130 may control the frequency of the virtual sound based on the driving information, and may output the virtual sound at the controlled frequency through the sound output module 140. In other words, the processor 130 may obtain an input factor in response to the actuation of the in-wheel system from the driving information, and may control the frequency of the virtual sound based on the obtained input factor. In this case, the processor 130 may control the volume of the virtual sound to output the virtual sound corresponding to the level of the operating noise of the in-wheel system.

The processor 130 may output a virtual sound through the sound output module 140 based on the input factor (driving information) in response to the actuation of the in-wheel system from the driving information.

For example, while the vehicle is traveling, the processor 130 may output a virtual sound through the sound output module 140 based on the driving information such as a steering angle, a gear value, a wheel speed, and a motor torque. In this case, the volume of the virtual sound may be determined in proportion to the magnitude of the steering angle, gear value, wheel speed, and motor torque.

In addition, when the vehicle speed is less than a reference value (e.g., 20 kph), the processor 130 may output a virtual sound through the sound output module 140 based on the input factor (driving information) in response to the actuation of the in-wheel system. For example, the processor 130 may output a virtual sound based on at least one input factor (driving information) from among a steering angle, a gear value, a wheel speed, and a motor torque. In this case, the volume of the virtual sound may be determined in proportion to the magnitude of at least one of the steering angle, the gear value, the wheel speed, and the motor torque.

In addition, the processor 130 may load, from the memory 120, the default virtual sound for the input factor in response to the actuation of the in-wheel system or the virtual sound generated using the sound source selected by the user to output the above virtual sound through the sound output module 140 specified in the sound output module allocation table.

Since a plurality of sound output modules 140 are provided inside and outside the vehicle, the processor 130 may control the plurality of sound output modules 140 to selectively output virtual sounds. In other words, the processor 130 may allocate a sound output module 140 to output the virtual sound based on the sound output module allocation table.

In addition, the processor 130 may change the virtual sound, set as default for the input factor in response to the actuation of the in-wheel system, to a sound source selected by the user, and may output the changed sound source as a virtual sound. In other words, when the vehicle is shipped, a default virtual sound may be set for the input factor (driving information) in response to the actuation of the in-wheel system. Accordingly, the user may change the default virtual sound, set for the input factor (driving information) in response to the actuation of the in-wheel system, to his/her desired sound source. For example, the user may change the default virtual sound to various sound sources such as DYNAMIC, CYBER, and SPORT.

Moreover, the processor 130 may control at least one of the frequency and volume of the virtual sound based on at least one of the frequency characteristics and level of operating noise due to the actuation of the in-wheel system.

To this end, the system for controlling virtual sound for vehicles 100 according to the present disclosure may further include a microphone that detects operating noise incurred by the actuation of the in-wheel system while the vehicle is traveling. The processor 130 may control the volume of the virtual sound to output the virtual sound corresponding to the level of the operating noise due to the actuation of the in-wheel system detected through the microphone.

Next, the operation of the processor 130 for outputting virtual sound in the braking system will be described.

In the braking system, the processor 130 may output a virtual sound through the sound output module 140 based on the driving information. Here, the driving information may include a brake operation on/off status, a brake cylinder pressure, a vehicle longitudinal/lateral acceleration, a vehicle speed, gear values (P, R, N, and D), a steering angle, wheel speeds (for 4 front/rear wheels), whether an ABS is in operation, and so on.

If the braking system is actuated, the processor 130 may receive the driving information of the vehicle through the communication module 110, control the frequency of the virtual sound based on the driving information, and output the virtual sound at the controlled frequency through the sound output module 140. In other words, the processor 130 may obtain an input factor in response to the actuation of the braking system from the driving information, and may control the frequency of the virtual sound based on the obtained input factor. In this case, the processor 130 may control the volume of the virtual sound to output the virtual sound corresponding to the level of the operating noise of the braking system.

The processor 130 may output a virtual sound through the sound output module 140 based on the input factor (driving information) in response to the actuation of the braking system from the driving information.

For example, if the vehicle speed is equal to or higher than a reference value (e.g., 20 kph) and the cylinder hydraulic pressure is equal to or higher than a preset first reference hydraulic pressure, the processor 130 may determine that a braking signal for deceleration is input during traveling and may output a virtual sound in response to the vehicle speed and the cylinder hydraulic pressure. In this case, the volume of the virtual sound may be determined in proportion to the magnitude of the vehicle speed and cylinder hydraulic pressure.

On the other hand, if the vehicle speed is less than a reference value (e.g., 20 kph) and the cylinder hydraulic pressure is equal to or higher than a preset second reference hydraulic pressure, the processor 130 may determine that a braking signal for parking is input and may output a virtual sound in response to the vehicle speed and the cylinder hydraulic pressure. In this case, the volume of the virtual sound may be determined in proportion to the magnitude of the vehicle speed and cylinder hydraulic pressure. Here, the second reference hydraulic pressure may be a larger value than the first reference hydraulic pressure.

In addition, if the processor 130 receives an ABS operation signal, the processor 130 may mask noise incurred during ABS operation and output a virtual sound that can give the driver a sense of stability.

In addition, the processor 130 may load, from the memory 120, the default virtual sound for the input factor in response to the actuation of the braking system or the virtual sound generated using the sound source selected by the user to output the above virtual sound through the sound output module 140 specified in the sound output module allocation table.

Since a plurality of sound output modules 140 are provided inside and outside the vehicle, the processor 130 may control the plurality of sound output modules 140 to selectively output virtual sounds. In other words, the processor 130 may allocate a sound output module 140 to output the virtual sound based on the sound output module allocation table.

In addition, the processor 130 may change the virtual sound, set as default for the input factor in response to the actuation of the braking system, to a sound source selected by the user, and may output the changed sound source as a virtual sound. In other words, when the vehicle is shipped, a default virtual sound may be set for the input factor (driving information) in response to the actuation of the braking system. Accordingly, the user may change the default virtual sound, set for the input factor (driving information) in response to the actuation of the braking system, to his/her desired sound source. For example, the user may change the default virtual sound to various sound sources such as DYNAMIC, CYBER, and SPORT.

Moreover, the processor 130 may control at least one of the frequency and volume of the virtual sound based on at least one of the frequency characteristics and level of operating noise due to the actuation of the braking system.

To this end, the system for controlling virtual sound for vehicles 100 according to the present disclosure may further include a microphone that detects operating noise incurred by the actuation of the braking system while the vehicle is traveling. The processor 130 may control the volume of the virtual sound to output the virtual sound corresponding to the level of the operating noise due to the actuation of the braking system detected through the microphone.

Finally, the operation of the processor 130 for outputting virtual sound in response to operation of the small vehicle components will be described.

The processor 130 may load, from the memory 120, the virtual sound in response to the operating component based on the component operation signal (e.g., default virtual sound or virtual sound generated using the sound source selected by the user) and may output the above virtual sound through the sound output module 140.

The processor 130 may receive component operation signals (e.g., component operation start and end signals) and information about the type of operating component from the ECU through the communication module 110. Examples of the type of operating component include a wiper, an air-conditioning system, a window, a sunroof, an electric seat, a pop-up monitor, and a side-view mirror. Examples of the component operation signals include wiper operation start/end, air-conditioning system operation start/end, window operation start/end, sunroof operation start/end, electric seat operation start/end, pop-up monitor operation start/end, and side-view mirror operation start/end.

Hereinafter, the operation of generating virtual sound for each operating component based on the specified virtual sound generation algorithm and outputting the virtual sound based on the sound output module allocation table for each component operation noise will be described as an example.

Hereinafter, in this embodiment, the sound output module 140 may be simply described as a speaker, and it is assumed that the vehicle is equipped with front speakers (mid-bass+treble) 141 and 142, front tweeter speakers (treble) 143 and 144, and rear speakers (mid-bass+treble) 145 and 146.

In this embodiment, the component operation noise may be divided into temporary component operation noise (e.g., \textcircled{a}: vehicle window, \textcircled{b}: sunroof operation signal, \textcircled{c}: electric seat, \textcircled{d}: pop-up monitor, and \textcircled{e}: side-view mirror) and continuous component operation noise (e.g., \textcircled{f}-1: air-conditioning system signal, \textcircled{f}-2: air-conditioning setting mode, \textcircled{f}-3: air-conditioning system intensity, and \textcircled{g}: vehicle wiper signal).

In this embodiment, it is assumed that the sound source for each operating component (e.g., \textcircled{1}: window brand sound, \textcircled{2}: sunroof brand sound, \textcircled{3}: electric seat brand sound, \textcircled{4}: pop-up monitor brand sound, \textcircled{5}: side-view mirror brand sound, \textcircled{6}: vehicle air-conditioning system brand sound, or \textcircled{7}: vehicle wiper brand sound) and the frequency characteristics for each component operation noise (e.g., (a): vehicle air-conditioning system sound main frequency or (b): vehicle wiper sound main frequency) are stored in the memory 120.

However, it is noted that this embodiment is not intended to limit the installation position and number of speakers, and it is intended to describe the operation of outputting virtual sound (e.g., loading and outputting previously created virtual sound or generating and outputting virtual sound) by allocating the sound output module 140 for each component operation noise per situation (CASE).

The processor 130 may apply a notch filter corresponding to the frequency characteristic (a) or (b) for the operating component that incurs continuous component operation noise to the sound source for each operating component (\textcircled{1}, \textcircled{2}, \textcircled{3}, \textcircled{4}, or \textcircled{5}) that incurs temporary component operation noise (for example, (\textcircled{1}, \textcircled{2}, \textcircled{3}, \textcircled{4}, \textcircled{5})->(\textcircled{1}-a, \textcircled{2}-a, \textcircled{3}-a, \textcircled{4}-a, \textcircled{5}-a) or (\textcircled{1}, \textcircled{2}, \textcircled{3}, \textcircled{4}, \textcircled{5})->(\textcircled{1}-b, \textcircled{2}-b, \textcircled{3}-b, \textcircled{4}-b, \textcircled{5}-b)).

In addition, when the mode (\textcircled{f}-2) of the operating component (e.g., air-conditioning system) that incurs continuous component operation noise is an air conditioner, the corresponding sound source (\textcircled{6}-1) is output, in which case the sound volume may be determined in proportion to the air-conditioning system intensity (\textcircled{f}-3) signal.

In addition, when the mode (\textcircled{f}-2) of the operating component (e.g., air-conditioning system) that incurs continuous component operation noise is a heater, the corresponding sound source (\textcircled{6}-2) is output, in which case the sound volume may be determined in proportion to the air-conditioning system intensity (\textcircled{f}-3) signal.

In addition, when the operating component (\textcircled{g}) that incurs continuous component operation noise is a wiper, the speaker volume may be determined proportionally depending on the mode (i.e., speed) of the wiper system, namely, the first-level mode, second-level mode, third-level mode, etc. of the wiper system.

Meanwhile, when individual opening/closing signals are detected from a plurality of vehicle windows (e.g., \textcircled{a}-1, \textcircled{a}-2, \textcircled{a}-3, and \textcircled{a}-4), the virtual sound corresponding to the opening/closing may be output through the specified speakers 141 to 146. In addition, even when two or more windows are opened/closed at the same time, the virtual sound corresponding to the opening/closing may be output through the specified speakers 141 to 146.

When the opening/closing signal of the sunroof (\textcircled{b}) is detected from among the operating components that incur temporary component operation noise, the virtual sound corresponding to the opening/closing may be output through the specified speakers 141 to 146.

When the signals of operation of multiple electric seats (\textcircled{c}-1, \textcircled{c}-2, \textcircled{c}-3, and \textcircled{c}-4) are detected individually or simultaneously from among the operating components that incur temporary component operation noise, the virtual sound corresponding to movement of the seats may be output through the specified speakers 141 to 146.

When the up or down signal of the pop-up monitor (\textcircled{d}) is detected from among the operating components that incur temporary component operation noise, the virtual sound corresponding to movement of the pop-up monitor may be output through the specified speakers 141 to 146.

When the ON/OFF signal of the side-view mirror (\textcircled{e}) is detected from among the operating components that incur temporary component operation noise, the virtual sound corresponding to movement of the side-view mirror may be output through the specified speakers 141 to 146.

In this case, the virtual sound may be generated by applying a notch filter corresponding to the frequency characteristic (a) or (b) for each operating component that incurs continuous component operation noise to the sound source for each operating component that incurs temporary component operation noise.

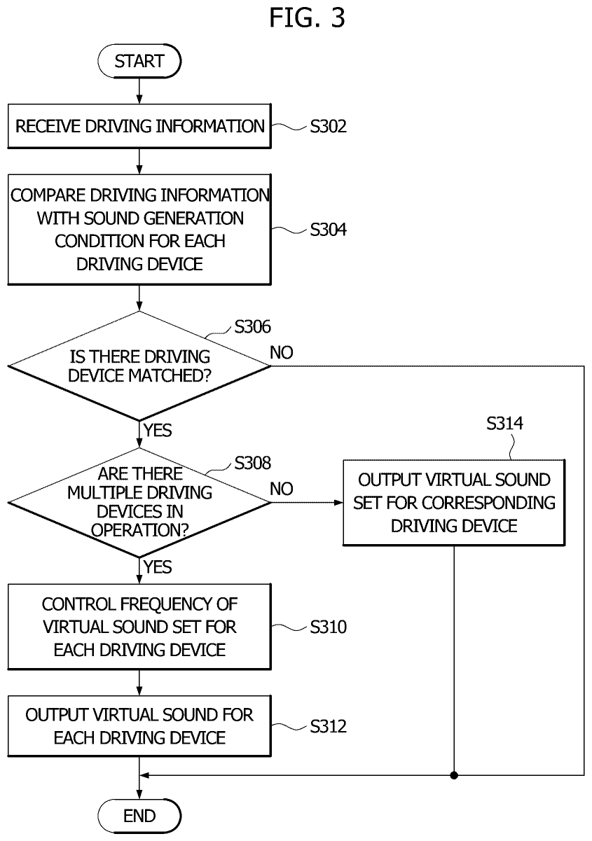

FIG. 3 is a flowchart for explaining a method of outputting virtual sound in the chassis system according to the embodiment of the present disclosure.

Referring to FIG. 3, if the processor 130 receives driving information of the vehicle (S302), the processor 130 compares the driving information with a sound generation condition for each driving device (S304) to determine whether a driving device is present whose sound generation condition matches the driving information (S306). Here, the driving information may include a brake operation on/off status, a brake cylinder pressure, a vehicle longitudinal/lateral acceleration, a vehicle speed, gear values (P, R, N, and D), a steering angle, a steering angular velocity, a motor torque, wheel speeds (for 4 front/rear wheels), an engine RPM and torque, and so on.

Since the sound generation condition is set for each driving device, the processor 130 may determine which driving device is in operation by matching the driving information with the sound generation condition.

As a result of the determination in step S306, if a driving device is present whose sound generation condition matches the driving information, the processor 130 determines whether there are a plurality of driving devices in operation (S308).

As a result of the determination in step S308, if there are a plurality of driving devices in operation, the processor 130 controls the frequency of the virtual sound set for each driving device (S310) and outputs the virtual sound for each driving device (S312). In other words, when a plurality of driving devices are in operation, the processor 130 may tune the frequency of the virtual sound with high priority to be higher based on the priority set for each driving device, and may output the same. When the plurality of driving devices are actuated, the processor 130 may control the plurality of sound output modules 140 to selectively output virtual sounds for different driving devices, and may control the virtual sound for each driving device to be output at a specific frequency therefor. In this case, the processor 130 may control the volume of the virtual sound to output the virtual sound corresponding to the level of the driving device operation noise detected through the microphone.

As a result of the determination in step S308, if there are not a plurality of driving devices in operation, the processor 130 outputs the virtual sound set for the corresponding driving device (S314). In this case, the processor 130 may control the volume of the virtual sound to output the virtual sound corresponding to the level of the driving device operation noise detected through the microphone.

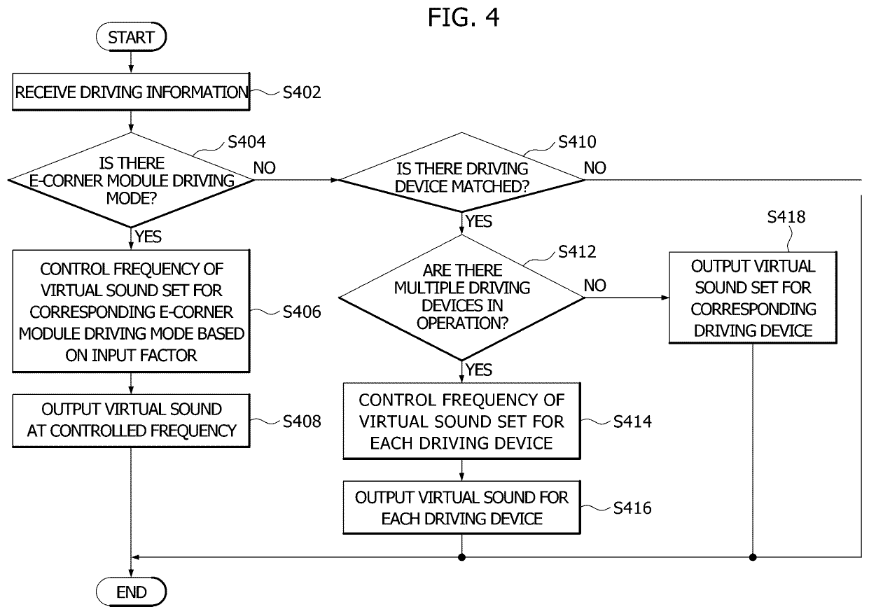

FIG. 4 is a flowchart for explaining a method of outputting virtual sound in the e-corner module system according to the embodiment of the present disclosure.

Referring to FIG. 4, if the processor 130 receives driving information of the vehicle (S402), the processor 130 determines whether an e-corner module driving mode is present in the driving information (S404). Here, the driving information may include a brake operation on/off status, a brake cylinder pressure, a vehicle longitudinal/lateral acceleration, a vehicle speed, gear values (P, R, N, and D), a steering angle, a steering angular velocity, a motor torque, wheel speeds (for 4 front/rear wheels), an engine RPM and torque, an e-corner module driving mode, and so on. The e-corner module driving mode may include a crap driving mode, a zero turn mode, a diagonal driving mode, a pivot turn mode, etc.

As a result of the determination in step S404, if the e-corner module driving mode is present in the driving information, the processor 130 controls the frequency of the virtual sound set for that e-corner module driving mode based on the input factor (S406), and output the virtual sound at the controlled frequency through the sound output module 140 (S408). In this case, the processor 130 may control the volume of the virtual sound to output the virtual sound corresponding to the level of the operating noise in the e-corner module driving mode.

As a result of the determination in step S404, if the e-corner module driving mode is not present in the driving information, the processor 130 compares the driving information with a sound generation condition for each driving device to determine whether a driving device is present whose sound generation condition matches the driving information (S410).

As a result of the determination in step S410, if a driving device is present whose sound generation condition matches the driving information, the processor 130 determines whether there are a plurality of driving devices in operation (S412).

As a result of the determination in step S412, if there are a plurality of driving devices in operation, the processor 130 controls the frequency of the virtual sound set for each driving device (S414) and outputs the virtual sound for each driving device (S416). In other words, when a plurality of driving devices are in operation, the processor 130 may tune the frequency of the virtual sound with high priority to be higher based on the priority set for each driving device, and may output the same.

As a result of the determination in step S412, if there are not a plurality of driving devices in operation, the processor 130 outputs the virtual sound set for the corresponding driving device (S418). In this case, the processor 130 may control the volume of the virtual sound to output the virtual sound corresponding to the level of the driving device operation noise detected through the microphone.

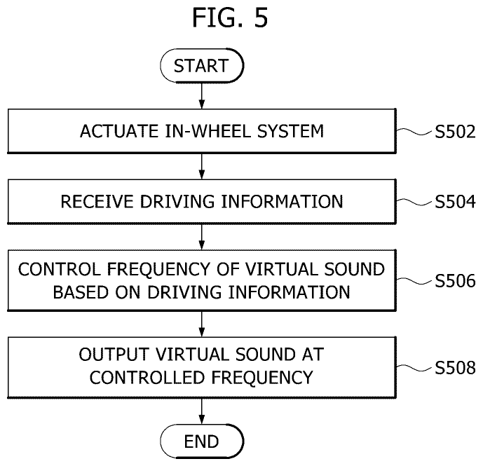

FIG. 5 is a flowchart for explaining a method of outputting virtual sound in the in-wheel system according to the embodiment of the present disclosure.

Referring to FIG. 5, if the in-wheel system is actuated (S502), the processor 130 receives driving information of the vehicle (S504). Here, the driving information may include a brake operation on/off status, a brake cylinder pressure, a vehicle longitudinal/lateral acceleration, a vehicle speed, gear values (P, R, N, and D), a steering angle, wheel speeds (for 4 front/rear wheels), an in-wheel motor torque, and so on.

If step S504 is performed, the processor 130 controls the frequency of the virtual sound based on the driving information (S506), and outputs the virtual sound at the controlled frequency through the sound output module 140 (S508). In this case, the processor 130 may control the volume of the virtual sound to output the virtual sound corresponding to the level of the operating noise of the in-wheel system.

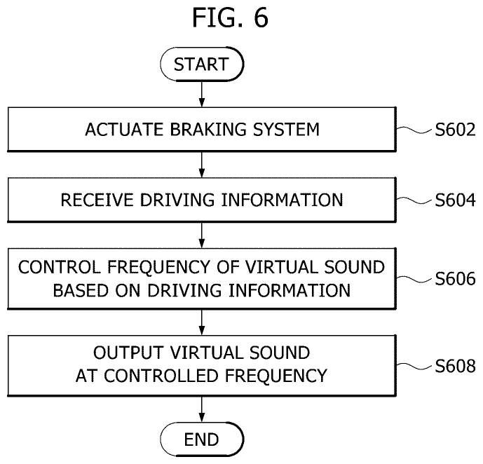

FIG. 6 is a flowchart for explaining a method of outputting virtual sound in the braking system according to the embodiment of the present disclosure.

Referring to FIG. 6, if the braking system is actuated (S602), the processor 130 receives driving information of the vehicle (S604). Here, the driving information may include a brake operation on/off status, a brake cylinder pressure, a vehicle longitudinal/lateral acceleration, a vehicle speed, gear values (P, R, N, and D), a steering angle, wheel speeds (for 4 front/rear wheels), whether an ABS is in operation, and so on.

If step S604 is performed, the processor 130 controls the frequency of the virtual sound based on the driving information (S606), and outputs the virtual sound at the controlled frequency through the sound output module 140 (S608). In this case, the processor 130 may control the volume of the virtual sound to output the virtual sound corresponding to the level of the operating noise of the braking system.

For example, when the cylinder hydraulic pressure and the vehicle speed are higher than reference values, the processor 130 may output the virtual sound at a higher frequency.

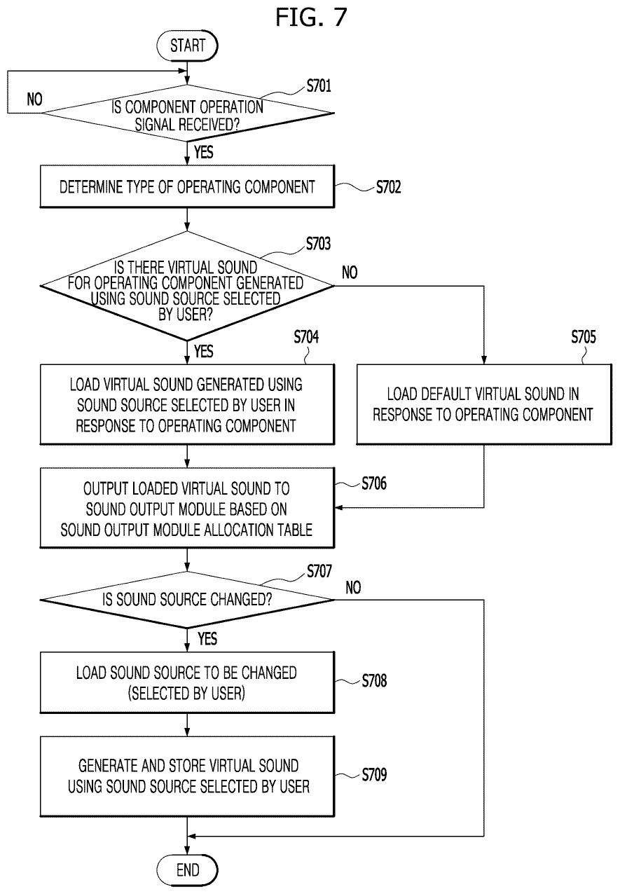

FIG. 7 is a flowchart for explaining a method of outputting virtual sound in response to operation of small vehicle components according to the embodiment of the present disclosure.

Referring to FIG. 7, if the processor 130 receives a component operation signal from the ECU of the vehicle (YES in S701), the processor 130 may determine the type of corresponding operating component (S702).

For example, the processor 130 may receive information about the type of operating component that incurs component operation noise due to component operation from the ECU of the vehicle.

If the type of operating component that incurs component operation noise is determined, the processor 130 checks whether the virtual sound for the operating component generated using the sound source selected by the user is stored in the memory 120 (S703).

If the virtual sound for the operating component that incurs component operation noise is stored in the memory 120 (YES in S703), the virtual sound in response to the operating component (i.e., the virtual sound for the operating component generated using the sound source selected by the user) is loaded from the memory 120 (S704).

If the virtual sound for the operating component that incurs component operation noise is not stored in the memory 120 (No in S703), the default virtual sound in response to the operating component is loaded from the memory 120 (S705).

The processor 130 outputs the virtual sound (e.g., default virtual sound or virtual sound generated using the sound source selected by the user) loaded from the memory 120 to the sound output modules 141 to 146 based on the sound output module allocation table (S706). Here, the sound output module allocation table stores a sound output module allocation value that has the best effect in inducing operating noise to the sound source by performing a test based on the installed position and number of sound output modules (e.g., sound amplifier, speaker, etc.) for each vehicle. The sound output module allocation table may further include sound volume and equalizer information for each sound output module 140.

In this case, if the user inputs a sound source change command (YES in S707), the processor 130 loads the sound source to be changed (i.e., selected by the user) from the memory 120 (S708).

Then, the processor 130 generates a virtual sound based on the specified virtual sound generation algorithm using the sound source loaded from the memory 120 (i.e., sound source selected by the user) and stores the same in the memory 120 (S709).

In this way, the virtual sound stored in the memory 120 is loaded and output in priority over the default virtual sound when component operation noise is incurred.

As described above, the present embodiment has the effect of reducing field claims for component operation noise by drawing attention to the noise sound output in this embodiment from the interest in component operation noise incurring in the interior of an existing vehicle. In addition, by reducing sensitivity to component operation noise, it is possible to reduce research and development costs and time to reduce noise actually incurred from the component itself.

The present disclosure can improve the user's sensitivity to or response to driving device operation noise by lowering the user's level of interest in operating noise of the driving devices, the e-corner module driving mode, the in-wheel system, the braking system, and the vehicle components through the output of virtual sound.

The present disclosure can give the user a sense of stability by setting virtual sounds in response to driving device actuation for chassis systems, e-corner module driving mode, in-wheel system actuation, and braking system actuation to a user's desired sound source, and outputting the virtual sound of the user's desired sound source when the driving device is actuated.

The present disclosure has the effect of reducing development costs and time due to reduced sensitivity to noise when developing chassis systems, e-corner modules, in-wheel systems, and braking systems.

The present disclosure has the effect of reducing field claims due to the driving noise masking effect and reducing costs during mass production of in-wheel systems or braking systems

Furthermore, the present embodiment has the effect of improving user's convenience by outputting noise sound according to the user's preference.

The present disclosure makes it possible to generate and output sound to reduce the user's interest in operating noise of the wiper and air-conditioning system of the vehicle.

In addition, the present disclosure is intended to output sounds to reduce the user's interest in operating noise incurred by the driving devices (e.g., power transmission device, braking device, steering device, suspension device, etc.) for the chassis system, the e-corner module driving mode, the in-wheel system, the braking system, and the wiper and air-conditioning system of the vehicle.

The present invention has the effect of improving the user's sensitivity to or response to component operation noise by lowering the user's level of interest in component operation noise of the vehicle through the output of virtual sound.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A system for controlling virtual sound for a vehicle, comprising:
one or more processors configured to execute instructions; and
a memory storing the instructions, wherein execution of the instructions configures the one or more processors to:
compare driving information with a sound generation condition for each driving device of the vehicle;
determine whether a sound generation condition of a respective driving device matches the driving information; and
responsive to determining that the respective driving device matches the driving information, outputting a virtual sound set for the respective driving device through a sound output device.

2. The system according to claim 1, wherein the processors are further configured to:
responsive to a determination that two or more driving devices include respective sound generation conditions that match the driving information as matching driving devices, controlling a respective frequency of a respective virtual sound set for each of the matching driving devices while outputting a respective virtual sound for each of the matching driving devices.

3. The system according to claim 2, wherein the processors are further configured to
tune respective frequencies, based on a respective, predetermined priority for driving device.

4. The system according to claim 2, wherein the processors are further configured to:
control one or more of a frequency and a volume of a respective virtual sound based on respective frequency characteristics and a respective level of operating noise incurred by the driving devices.

5. The system according to claim 1, wherein the processors are further configured to:
select one or more sound output devices to output respective virtual sounds based on a sound output allocation table; and
output the respective virtual sounds through the one or more selected sound output devices.

6. A system for controlling virtual sound for a vehicle, comprising:
one or more processors configured to execute instructions; and
a memory storing the instructions, wherein execution of the instructions configures the one or more processors to:
control a frequency of a virtual sound based on driving information during an operation of a vehicle system; and
output the virtual sound at the controlled frequency through the a sound output device.

7. The system according to claim 6, wherein the vehicle system comprises an e-corner system, and
wherein the processors are further configured to:
determine a mode type of an e-corner driving mode based on the driving information; and
output a virtual sound set for the determined mode type through the sound output device.

8. The system according to claim 7, wherein the processors are further configured to:
control a frequency of a virtual sound set for the determined mode type based on input factors, and
output the virtual sound at the controlled frequency through the sound output device.

9. The system according to claim 7, wherein the processors are further configured to:
control one or more of a frequency and a volume of a respective virtual sound based on one or more frequency characteristics and a level of an operating noise incurred in the e-corner driving mode.

10. The system according to claim 6, wherein the vehicle system comprises an in-wheel system, and
wherein the processors are further configured to:
control a volume of the virtual sound to output the virtual sound corresponding to a level of operating noise of the in-wheel system.

11. The system according to claim 10, wherein the processor is further configured to:
obtain an input factor in response to an actuation of the in-wheel system from the driving information; and
control the frequency of the virtual sound based on the obtained input factor.

12. The system according to claim 6, wherein the vehicle system comprises a braking system, and
wherein the processors are further configured to:
obtain an input factor in response to an actuation of a braking system from the driving information; and
control the frequency of the virtual sound based on the obtained input factor.

13. The system according to claim 12, wherein the processors are further configured to:
control a volume of the virtual sound to output the virtual sound corresponding to a noise level of an operating noise of the braking system.

14. The system according to claim 10, wherein the processors are further configured to:
change the virtual sound set for an input factor in response to an actuation of the vehicle system to a sound source selected by a user; and
output the changed sound source as a virtual sound.

15. A system for controlling virtual sound for a vehicle, comprising:
a communication device configured to communicate with an electronic control unit (ECU) in a vehicle;
one or more processors configured to execute instructions; and
a memory storing the instructions, wherein execution of the instructions configures the one or more processors to:
receive a component operation signal and information of a type of an operating component from the communication device; and
output a virtual sound corresponding to component operation noise incurred by the operating component through a sound output device.

16. The system according to claim 15, wherein the component operation signal is a signal for a start and an end of a component operation.

17. The system according to claim 15, further comprising:
a storage device configured to store one or more of frequency characteristics for each component operation noise, a sound source, a virtual sound generation algorithm, a virtual sound generated using a pre-generated default virtual sound or a sound source selected by a user, and a sound output allocation table according to the virtual sound.

18. The system according to claim 15, wherein the virtual sound includes one or more of frequency characteristics for each component operation noise with a sound source and frequency characteristics of the component operation noise as an element of music to hide the component operation noise.

19. The system according to claim 15, wherein the processors are further configured to:
load, from a storage device, a default virtual sound for the operating component based on one of the component operation signal and a virtual sound generated from a user selected sound source; and
select the sound output device from one or more sound output devices to output the default virtual sound through the selected sound output as specified in a sound output allocation table.

20. The system according to claim 19, wherein the sound output allocation table includes sound output allocation values indicating an effect in inducing component operation noise to the sound source according to a predetermined value based on an installed position and a number of sound output devices for the vehicle, and
wherein the sound output allocation table includes sound volume and equalizer information for each sound output.
